(19) United States
(12) Patent Application Publication
(10) Pub. No.: US 2010/0289834 A1
(43) Pub. Date: Nov. 18, 2010

(54) FIELD COLOR SEQUENTIAL DISPLAY CONTROL SYSTEM

(75) Inventors: Yung Ching LEE, Hsinchu (TW); Ching-Hsiang Hsu, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: FARADAY TECHNOLOGY CORPORATION, Hsinchu (TW)

(21) Appl. No.: 12/775,585

(22) Filed: May 7, 2010

(30) Foreign Application Priority Data
May 13, 2009 (TW) 098115881

(51) Int. Cl. G09G 5/10

(52) U.S. Cl. 345/690

(57) ABSTRACT

Field color sequential (FCS) control system applied for an FCS display device is provided. The FCS control system includes an input system, a memory and an output system. The input system, including a plurality of buffers respectively corresponding to different color channels, receives different color channel components of pixels in parallel such that components of a same color channel are stored in a same buffer. The memory, including a plurality of partitions respectively corresponding to different color channels, stores components of a same color channel to a same partition in association with triggering of rising and falling edges of a clock, respectively. The output system sequentially buffers and outputs color channel components of corresponding partitions.

### FIELD OF THE INVENTION

The present invention relates to a field color sequential (FCS) display control system, and more particularly, to an FCS display control system optimized according to demands of FCS display device.

### BACKGROUND OF THE INVENTION

Display device is one of the most important human-machine interfaces of modern information systems, to achieve better visualization with lower power has become a key issue for designers and developers of modern display device.

FCS (Field Color Sequential) principle is a technique for combining and displaying color images. Among various imaging techniques for displaying colors by combining colors with three prime colors, one of them is combining/mixing colors in space. To combine colors in space, associated display panel is equipped with three sub-pixels, respectively corresponding to three prime colors, for each pixel of the image. By respectively controlling intensity/luminance of each sub-pixel, various colors can be combined spatially for each pixel. To implement such spatial color combination with current LCD (Liquid Cristal Display) panel, different sub-pixels are formed with different color filter films. For example, a green sub-pixel is covered with a color filter film for filtering red and blue; therefore, when a white backlight penetrates through the sub-pixel, only green component passes to make the sub-pixel show green.

However, spatial color combination also suffers lower power efficiency owing to aforementioned color filtering. Because color filtering filtrates a portion of light energy provided by white backlight, light energy of filtered components is wasted. Therefore, spatial color combination is difficult to match modern trend of low power. In addition, since each display unit of the panel for a pixel must contain three sub-pixels with three independent luminance controls, area of each display unit becomes large to decrease resolution of the panel/image.

Comparing to the spatial color combination, FCS principle can be understood as a temporal color combination. For a display panel applying FCS principle, each display unit for a pixel only need a single intensity/luminance control, rather than three independent luminance controls for three sub-pixels in spatial color combination. In addition, each display unit for FCS principle color combination does not need color filter films. While applying FCS principle in a typical embodiment, a color image of a frame is displayed by: respectively writing luminance control of each display unit corresponding to red component of each pixel in association with a red light source, then respectively writing luminance control of each display unit corresponding to green component of each pixel in association with a green light source, and respectively writing luminance control of each display unit corresponding to blue component of each pixel in association with a blue light source. In other words, this embodiment sequentially displays red component image (also referred to as a red color field), green component image (a green color field) and blue component image (a blue color field) to combine/mix a color image of various colors by human visual persistence.

Based on FCS principle, because light sources of different (prime) colors are utilized for color combination, no color filter films are required, and therefore energy efficiency can be effectively increased. Under some applications, energy consumed based on FCS principles is only 30% of that based on spatial color combination. Also, resolution of image/panel based on FCS principle is raised since equivalently only one sub-pixel is needed for each display unit corresponding to each pixel.

However, it is understood from aforementioned discussion that all components of all pixels corresponding to each color channel need to be collected to a color field for convenience of temporal color combination. Thus, a display control system specially optimized for specific needs of FCS principle is demanded.

### SUMMARY OF THE INVENTION

Therefore, the invention provides an FCS display control system optimized to meet specific needs of FCS display devices. In an embodiment of the invention, the FCS display control system has an input system, a memory, an output system and a controller to operate with a light control module and a panel control module. The FCS display system of the invention receives an image data and controls an FCS display device for displaying corresponding images based on FCS principle. The image data corresponds to at least a frame, each frame includes a plurality of scan lines, each scan line has a plurality of pixels and a corresponding blanking period. Each pixel corresponds to a plurality of color channels and has a component corresponding to each of the color channels. The input system includes a plurality of buffers, each buffer corresponds to one of the plurality of color channels. The input system receives the components corresponding to the color channels of each pixel from a bus in a parallel manner, and stores the components of each color channel to the buffer corresponding to a same color channel, such that the components of different color channels are stored in different buffers. In a preferred embodiment, each buffer stores all components of a same color channel of a same scan line, i.e., all components of the same color channel belonging to all pixels in the scan line.

The memory is divided into a plurality of partitions; each of the plurality of partitions corresponds to one of the plurality of color channels for storing data. In a preferred embodiment, each partition stores all components of a same color channel of a same frame, i.e., a color field. The output system buffers data. The controller controls each buffer corresponding to a color channel to transmit stored components to an associated partition corresponding to a same color channel, and controls data transmission from each partition to the output system according to color channel requirements.

In an embodiment of the FCS display control system, the controller controls each of the buffers respectively corresponding to one of the color channels to transmit stored components to the partition corresponding to a same color channel according to the blanking period.

In an embodiment of the FCS display system, the memory accesses data in response to rising edges and falling edges of a clock, and the controller sequentially controls each of the buffers to transmit stored components to corresponding partition in a burst mode synchronized with the rising edges and falling edges of the clock. For example, the controller synchronizes transmission of some components of one of the color channels to the memory at one of the rising edges of the clock, and synchronizes transmission of another some components of a same color channel to the memory at one of the falling edges of the clock.

In an embodiment of the FCS display system, the memory is divided such that components of a same color channel can be accessed continuously; for example, components of a same color channel are grouped to be stored in adjacent addresses.

The light control module turns on and off a plurality of light sources independently, wherein each light source corresponds to one of the color channels. The panel control module controls a panel for displaying images. According to a color channel requirement, the output system buffers the partition corresponding to a same color channel. When the light control module turns on one of the light sources corresponding to one of the color channels, the output system synchronously writes the partition corresponding to a same color channel to the panel control module. If necessary, the output system further controls the panel control module for uniformly set the panel to display an image of a uniform color. The output system can also repeat to output at least one of the partitions, i.e., repeat to write at least one of the partitions to the panel control module.

### BRIEF DESCRIPTION OF THE DRAWINGS

The above contents of the present invention will become more readily apparent to those ordinarily skilled in the art after reviewing the following detailed description and accompanying drawings, in which:

FIG. 1 illustrates an FCS display control system applied to an FCS display device according to an embodiment of the invention;

FIG. 2 illustrates an exemplary operation of the FCS display control system shown in FIG. 1;

FIG. 3 to FIG. 5 demonstrate different color combination embodiments based on FCS principle; and

FIG. 6 shows a flow implementing the embodiment of FIG. 5 with the FCS display control system shown in FIG. 1.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

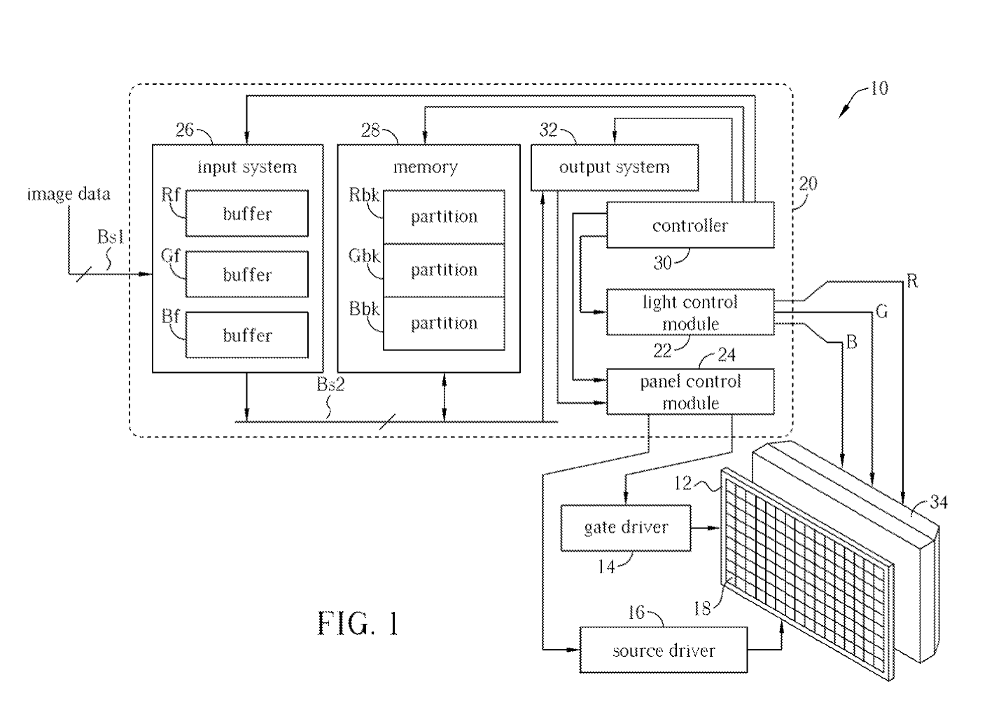

Please refer to FIG. 1 which illustrates an FCS display control system 20 applied to an FCS display device 10 according to an embodiment of the invention. The FCS display device 10 can be an FCS LCD display device or an FCS projector, it has a panel 12, a light source module 34, a gate driver 14 and a source driver 16. The light source module 34 provides light for the panel 12. The panel 12 has a plurality of display units 18, each display unit 18 corresponds to a pixel in an image of a frame. As previously discussed, while displaying color images based on FCS principle, there is no need to include sub-pixels of three prime colors in each display unit, thus each display unit 18 itself is equivalent to a single sub-pixel. For example, the panel 12 can be a thin-film transistor LCD panel with only one thin-film transistor in each display unit 18; the gate driver 14 and the source driver 16 respectively control gate and source of each thin-film transistor for changing light transparency of each display unit 18 to demonstrate images of various intensity/luminance. The light source module 34 provides light sources with each light source corresponding to a color channel, such as a red light source, a green light source and a blue light source. In the light module 34, each light source of a color channel can be independently turned on and off, e.g., the red light source on and both the blue light source and the green light source off.

The FCS display system 20 of the invention operates in respond to an (color) image data for controlling the FCS display device 10 to display corresponding images based on FCS principle. In current standard format of image data, the image data corresponds to at least a frame (wherein a still image can be considered as a single frame, motion images include a serial of frames), each frame includes a plurality scan lines (usually horizontal scan lines), each scan line has a plurality of pixels and a corresponding blanking period. Each pixel corresponds to a plurality of color channels (e.g., color channels of red, green and blue) and has a component corresponding to each of the color channels (e.g., red component, green component and blue component). To process the image data for specific needs of FCS principle, the FCS display control system 20 has an input system 26, a memory 28, an output system 32 and a controller 30 to operate with a light control module 22 and a panel control module 24. The input system 26 further includes a plurality of buffers, each buffer corresponding to one of the plurality of color channels. In the embodiment of FIG. 1, the input system 26 of the invention has three buffers Rf, Gf and Bf corresponding to color channels of red, green and blue, respectively. The input system 26 receives components (red, green and blue components) corresponding to color channels of each pixel from a bus Bs1 in a parallel manner, and the red components of the pixels are stored in the buffer Rf, the green components of the pixels are stored in the buffer Gf, and the blue components of the pixels are stored in the buffer Bf.

Corresponding to the three buffers Rf, Gf and Bf of the three color channels, the memory 28 of the invention is divided into three partitions Rbk, Gbk and Bbk. For example, the memory 28 can be a double data rate synchronous dynamic random access memory (DDR SDRAM), each of the partitions Rbk, Gbk and Bbk can be a memory bank in the memory 28. The input system 26 connects to the memory 28 through a bus Bs2, so the partitions Rbk, Gbk and Bbk can respectively store/collect data from the buffers Rf, Gf and Bf.

The output system 32 of the invention also includes a buffer for buffering data of at least one of the partitions. That is, the output system 32 receives data from at least one of the partitions Rbk, Gbk and Bbk and outputs received data to the panel control module 24 at proper timing. According to data transmitted from the output system 32, the panel control module 24 controls the gate driver 14 and the source driver 16. The light control module 22 turns on and off each light source of a color channel independently, and the controller 30 of the invention controls/coordinates operation timing of the input system 26, the memory 28, the output system 32, the light source control module 22 and the panel control module 24.

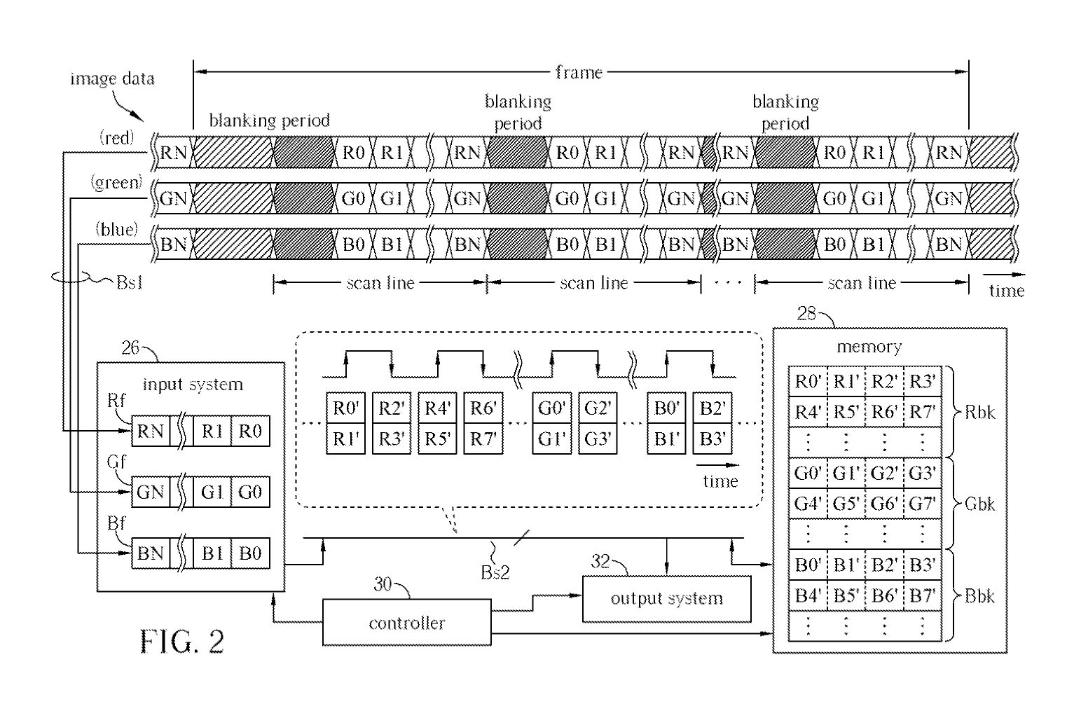

For further description of operation of the FCS display control system 20, please refer to FIG. 2 which illustrates organized operations of the input system 26, the memory 28, the output system 32 and the controller 30. As previously discussed, in modern image data (especially image data of high definition and high resolution), components of different color channels will be transmitted in parallel manner; as shown in FIG. 2, each frame can have a corresponding frame blanking period followed by scan lines of each frame. Each scan line has components of each pixel aligned sequentially and has a corresponding scan line blanking period separating between scan lines. For example, components R0, G0 and B0 are red, green and blue components of the 0-th pixel of a scan line; components R1, G1 and B1 represent red, green and blue components of the first pixel of the same scan line, and so forth. The last pixel of the same scan line has components RN, GN and BN. Components of different color channels of a pixel are simultaneously transmitted to the input system 26 through the bus Bs1 in a parallel manner.

In a preferred embodiment of the invention, each of the buffers Rf, Bf and Gf is implemented with a FIFO (first-in first-out) buffer, each buffer stores components belonging to all pixels of at least a scan line. As shown in FIG. 2, when the image data is transmitted to the FCS display control system 20, the input system 26 receives components of different color channels through the bus Bs1 in parallel manner, so the red components R0 to RN belonging to all pixels of a same scan line are stored in the buffer Rf, the green components G0 to GN belonging to all pixels of the same scan line are stored in the buffer Gf, and the blue components B0 to BN belonging to all pixels of the same scan line are stored in the buffer Bf. The controller 30 will monitor/count progress of forwarding components to corresponding buffers. During blanking period, after all components of a whole scan line of each color channel are stored in corresponding buffer, the controller 30 issues command(s) for sequentially writing components of each buffer to corresponding partition, i.e., storing red components in the buffer Rf to the partition Rbk, storing green components in the buffer Gf to the partition Gbk, and then storing blue components in the buffer Bf to the partition Bbk.

Transferring components from each buffer to the memory 28 during blanking periods can prevent potential mutual interference between the timing for inputting image data to the input system 26 and that for outputting from buffers to the memory 28. That is, since the buffers Rf, Gf and Bf transmit stored components to the memory 28 during a blank period following a scan line when components of the next scan line are not inputted to the input system 26, timing for outputting from each of the buffers Rf, Gf and Bf to the memory 28 is kept from potential interference. With such timing arrangement, each of the buffers Rf, Gf and Bf can be implemented by synchronous input/output scheme to simplify timing control mechanism and related circuit, and to avoid complexity of asynchronous input/output scheme. Moreover, because components of each color channel belonging to all pixels of a frame (i.e., a color field) should be displayed sequentially, components of each color channel belonging to all pixels in a scan line are collected to a corresponding buffer dedicated for each color channel in the beginning, such that the memory 28 can further gather and provide color fields of different color channels more readily and efficiently.

In a preferred embodiment of the invention, the memory 28 is capable of accessing data at both rising edges and falling edges of a clock for double data rate. While transmitting components in the buffers Rf, Gf and Bf to the memory 28, components of pixels are organized to groups according to bit width of the bus Bs2, so a group is transmitted from the input system 26 to the memory 28 by triggering of a rising edge of the clock, and a next group is transmitted from the input system 26 to the memory 28 by triggering of a falling edge of the clock. For example, assuming the bus Bs2 is a bus of 16-bit and each component in the image data (like components R0, G0 and B0) is of 6-bit, then 2 bits are attached to each 6-bit component to form a 8-bit component (e.g., 6-bit components R0, G0 and B0 are converted to 8-bit components R0′, G0′ and B0′, respectively), and every two 8-bit components are organized to a group of 16 bits, so a group can be transmitted to the memory 28 at either rising edge or falling edge of the clock. As shown in FIG. 2, according to components stored in the buffer Rf, 8-bit red components R0′ and R1′ of a scan line are organized to a group to be transmitted to the corresponding partition Rbk at a rising edge of the clock, the two componOents R2′ and R3′ of the next two pixels become next group to be transmitted to the partition Rbk at the falling edge of a same clock cycle, and so on.

To cooperate with data transmission scheme discussed above, each of the partitions Rbk, Gbk and Bbk stores component groups in blocks (e.g., words) of continuous address. For example, four red components R0′, R1′, R2′ and R3′ of 8-bit can be stored in a block of 32 bits, red components R4′, R5′, R6′ and R7′ of the next four pixels are stored in an adjacent 32-bit block (a block with continuous address), and so forth. The last 32-bit block of the partition Rbk can be adjacent to (i.e., have continuous address with) the first 32-bit block of the partition Gbk or not. Similarly, in the partition Gbk for green color channel, green components G0′, G1′, G2′ and G3′ are stored in a 32-bit block, green components G4′, G5′, G6′ and G7′ of the next four pixels are stored in a next 32-bit block (a block with continuous address). Blocks of adjacent addresses to be accessed continuously also apply to storing of blue components in the partition Bbk.

Because components are stored in aforementioned block configuration of continuous addresses, adjacent blocks of continuous addresses can efficiently accessed in burst mode. For example, during a blanking period of the image data, the controller 30 of the invention can transmit all components stored in the buffer Rf to the partition Rbk with a single burst mode access command, hence multiple access commands for controlling the memory 28 are prevented. Thus, according to the invention, commands required for accessing the memory 28 are effectively reduced to decrease resource (both power and timing) consumption of command overhead.

In a preferred embodiment of the invention, each of the partitions Rbk, Gbk and Bbk is capable of storing red components, green components and blue components belonging to all pixels in a frame, respectively. That is, the partition Rbk stores a red color field of a frame, the partition Gbk stores a green color field of the same frame, and the partition Bbk stores a blue color field of the frame. Correspondingly, the output system 32 of the invention buffers (stores) at least a color field. The output system 32 accesses the memory 28 for color fields according to color field requirements of the FCS display device 10, and stores accessed color field(s) in the input system 32 itself. Then, at proper time, the output system 32 outputs (writes) its buffered color field to the panel control module 24 (FIG. 1), and the light control module 22 will synchronously turn on the light source corresponding to the buffered color field, such that the color field can be displayed on the panel 12 with corresponding color. For example, when a red color field should be displayed in the FCS display device 10, the red color field is first buffered in the output system 32; at the moment the output system 32 writes the red color field to the panel control module 24, the light control module 22 synchronously turns on the red light source (with the green and blue light sources off), so the panel 12 can display the red color field with red. Similarly, when the output system 32 outputs the green color field, the light control module 22 simultaneously turns on the green light source (with the red and blue light sources off). Sequentially controlling the FCS display device 10 to display color fields of color channels according to color field requirements, color images can be mixed based on FCS principle.

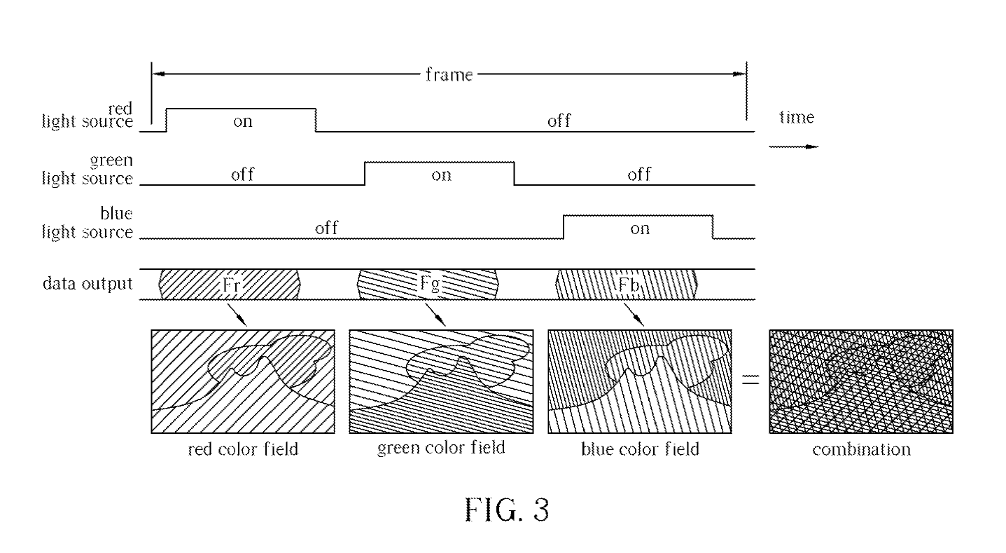

Please refer to FIG. 3 which illustrates an embodiment for displaying a color image based on FCS principle. The embodiment combines each color image with a sequence of a red color field, a green color field and a blue color field. To implement this FCS embodiment with the FCS display control system 20, color fields of color channels are respectively collected to the partitions Rbk, Gbk and Bbk. The output system 32 first accesses the red color field Fr from the partition Rbk, and writes (outputs) the red color field Fr to the panel control module 24 at a proper time when the light control module 22 synchronously turns on the red light source. Then the output system 32 accesses the green color field Fg from the partition Gbk; as the output system 32 outputs the green color field Fg to the panel control module 24, the light control module 22 also turns on the green light source. Next, the blue color field Fb is accessed from the partition Bbk by the output system 32 when the light control module 22 synchronously turns on the blue light source. As illustrated in FIG. 3, because components, of a same color channel, of different pixels are potentially different, each color field is usually not uniform, that is, each color field shows an inhomogeneous distribution of components with intensity/luminance varied at different pixels.

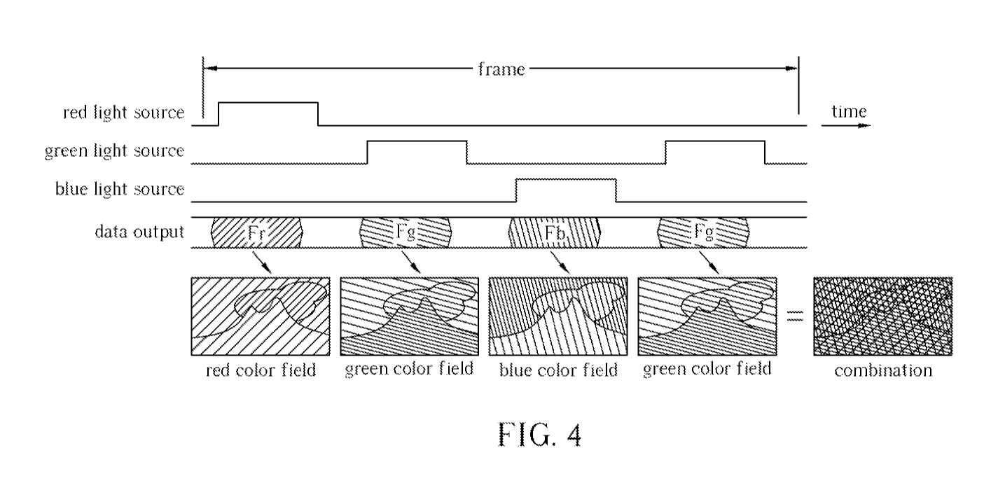

Please refer to FIG. 4 which illustrates another embodiment to display color images based on FCS principle. In this embodiment, a frame of a color image is combined by a red color field, a green color field, a blue color field and again a green color field. The FCS display control system 20 of the invention applies to this kind of FCS embodiment, too. With proper operations of the light control module 22, the output system 32 can sequentially access the red color field Fr, the green color field Fg, the blue color field Fb and again the green color field Fg from the partitions Rbk, Gbk and Bbk to implement this kind of FCS embodiment.

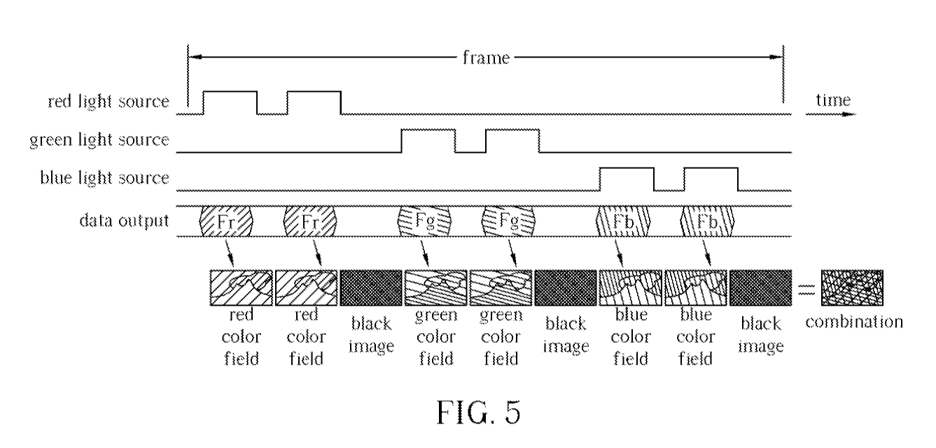

Please refer to FIG. 5 which illustrates still another embodiment to display color images based on FCS principle. In this FCS embodiment, each color field repeats twice with an image of a uniform color (e.g., a black image) inserted between color fields of different color channels. That is, this embodiment combines a color image with a sequence of a red color field, a repeated red color field, a black image, a green color field, a repeated green color field, a black image again and a blue color field and a repeated blue color field. Repeating a color field can enhance driving of the panel 12. For an LCD panel 12, because liquid crystal in each display unit changes states (orientations) slow with long response time, it may not fully change state on a single driving during a single color field. Therefore, driving the panel 12 twice with repeated color fields can enhance state change of liquid crystal such that each color field displayed by the panel 12 can approach true data of each color field. Insertion of black images also improves color combination to achieve more natural color mixing of better quality and purer color.

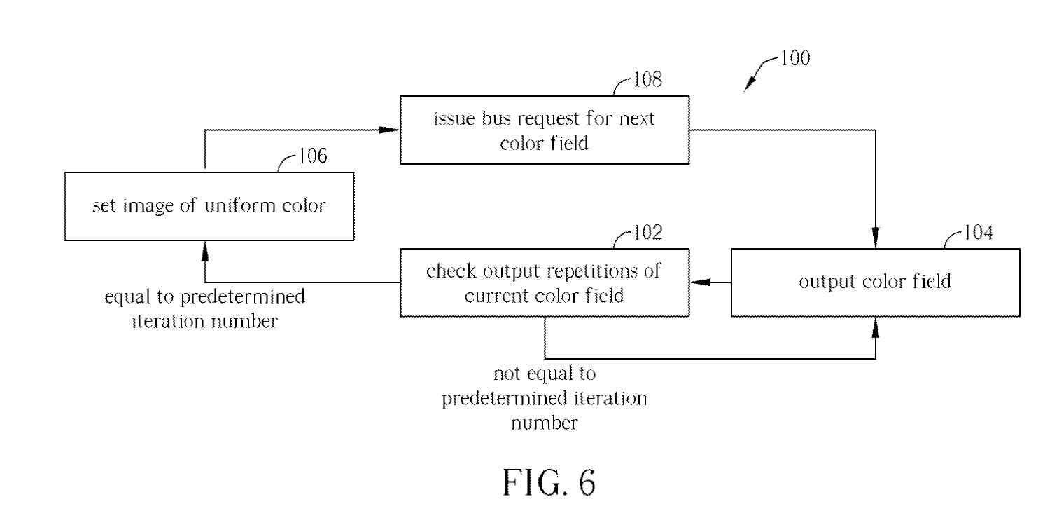

Please refer to FIG. 6 (along with FIG. 5), which demonstrates a flow 100 for implementing the FCS embodiment of FIG. 5 with the output system 32 according to an embodiment of the invention. Major steps of the flow 100 can be described as follows.
Step 102: check output repetitions of current color field. As discussed above, the output system 32 can buffer at least a color field. This step checks how many times (repetitions) the buffered color field has been written to the panel control module 24. If number of repetitions is less than a predetermined iteration number, go to step 104; if number of repetition has reached the predetermined iteration number, forward to step 106. In the example of FIG. 5, because each color field repeats twice, the predetermined iteration number is set to 2. In other words, if the current buffered color field has been written once, go to step 104; if it has been written twice to have its number of repetitions equal to 2 (the predetermined iteration number), then the flow can forward to step 106.
Step 104: the output system 32 outputs/writes its buffered color field to the panel control module 24. If this step is executed after step 102, it means that the color field has not been repeated for enough repetitions; therefore the output system 32 will provide the color field again. In the embodiment of FIG. 5, each color field needs to repeat twice. If the flow goes to this step from step 102, it implies that the buffered color field has been displayed only once; thus the output system 32 will outputs/writes the buffered color field to the panel control module 24 again in this step. In the meanwhile, the light control module 22 also turns on the light source corresponding to the buffered color field again to display the color field on the panel 12 once more.
Step 106: if a color field has been repeated enough with a repetition number equal to the predetermined iteration number, the output system 32 further controls the panel control module 24 to set the panel 12 uniformly, so the panel 12 displays an image of a uniform color (e.g., a black image). That is, each pixel (display unit) of the panel 12 is controlled to display the same color.
Step 108: the output system 32 issues a bus request to access the bus Bs2, so the next color field is accessed from the memory 28 to be buffered in the output system 32. Next, the flow 100 forwards to step 104 to display the next color field, and repeats it through step 102 and step 104.

From previous discussion about FIG. 3 to FIG. 5, it is understood that an FCS display control system has to handle frequent color field access for combining color images based on FCS principle. Generally speaking, an image data updates frames at a rate of 60 Hz, i.e., frames have to be displayed every 1/60 seconds. In the example of FIG. 3, a frame is combined by three color fields, so the color fields are updated at a rate of 180 Hz. The example in FIG. 4 requires color fields to be updated at a rate 240 Hz. The example discussed in FIG. 5 demands an even higher color field update rate of 540 Hz. In fact, in certain FCS embodiments, color fields are updates at a rate of 720 Hz. To respond these demands, disclosed techniques of the invention are adopted to optimize design and implementation of FCS display control systems. For example, designs and configurations of the input system 26 and the memory 28 are optimized in the invention. If each pixel's components of different color channels are not buffered respectively in different buffers, components of a same color channel can not be bulk transmitted to the memory with the burst mode. For instance, a typical input system design has a pixel's three components R0, G0 and B0 stored adjacently in a same buffer, and next pixel's components R1, G1 and B1 buffered adjacently next to the component B0. In this way, however, when components of red color channel R0 and R1 are collected to a red color field, they have to be accessed in a hopping manner: the component R0 is first accessed, then the component R1 is accessed with a jump over addresses of components G0 and B0. With such discontinuous accessing, the burst mode, in which components R0 and R1 (and other components of the same color channel) are bulk transmitted continuously, is difficult to be applied to this kind of typical input system, and this impact also compromises the efficiency for the memory to serve the output system. It is emphasized that the memory 28 not only receives components of pixels from the input system 26, but also provides color fields to the output system 32. Optimizing transmission efficiency from the input system 26 to the memory 28 with disclosed arrangement of the invention, more timing margins can be reserved for the memory 28 to satisfy demands of the output system 32, and then the output system 32 can fully support demands on color field update rates.

The input system 26, the output system 32, the controller 30, the light control module 22 and the panel control module 24 in the FCS display control system 20 of the invention can be integrated in a display timing control chip, the memory 28 can be a video memory (RAM) implemented with a memory chip (or a set of memory dice). Alternatively, the input system 26, the output system 32, the controller 30, the light control module 22, the panel control module 24 as well as the memory 28 can be integrated in a same chip. Or, the input system 26, the output system 32, the controller 30, the light control module 22, the panel control module 24, the gate driver 14 and the source driver 16 can be integrated in a same chip. The controller 30 can be implemented with software, hardware and/or firmware.

In addition to the input system 26, the output system 32, the controller 30, the light control module 22, the panel control module 24 and the memory 28, other function module(s) can be added to the FCS display control system 20 of the invention if necessary. For example, a pre-processor can be added before the input system 26, so the image data can be processed before being transmitted to the input system 26. Another processor module can be connected to the bus Bs2 for processing data stored in the buffers Rf, Gf and Bf before they are transmitted and stored in the memory 28, or for accessing and processing data already stored in the memory 28. A post-processor can also be added between the input system 32 and the panel control module 24 for processing data outputted by the output system 32 so the processed data can then be transmitted to the panel control module 24.

Comparing to prior art, the invention discloses an optimized design for the input system according to the feature that components of different color channels are transmitted in parallel in modern image data standard, as well as the specific needs of FCS principle. The invention also takes advantages of blanking periods and characteristics of double data rate for optimizing data transmission between the input system and the memory, so the output system can have enough margins for serving demands such as color field update rate. Also, the output system of the invention also includes considerations for special needs of various kinds of FCS embodiments, such as color field repetition and insertion of images of uniform color, so the image quality of FCS display device can be optimized with the output system of the invention.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A field color sequential (FCS) control system, operating in response to an image data which corresponds to at least a frame with each frame including a plurality of pixels, each pixel corresponding to a plurality of color channels and having a component corresponding to each of the color channels, comprising
an input system comprising:
a plurality of buffers, each of the plurality of buffers corresponding to one of the plurality of color channels; wherein the input system receives the components corresponding to the color channels of each pixel from a bus in a parallel manner, and stores the components of each color channel to the buffer corresponding to a same color channel, such that the components of different color channels are stored in different buffers;
a memory divided into a plurality of partitions, each of the plurality of partitions corresponding to one of the plurality of color channels for storing data;
an output system buffering data, and
a controller controlling each of the buffers respectively corresponding to one of the color channels to transmit stored components to the partition corresponding to a same color channel, and controlling data transmission from each of the partitions to the output system according to color channel requirements.

2. The FCS control system of claim 1, wherein each frame has a plurality of scan lines, each scan line has a plurality of pixels and corresponds to a blanking period, and the controller controls each of the buffers respectively corresponding to one of the color channels to transmit stored components to the partition corresponding to a same color channel according to the blanking period.

3. The FCS control system of claim 2, wherein each of the buffers stores components, of a scan line, corresponding to one of the color channels.

4. The FCS control system of claim 1, wherein the memory accesses data in response to rising edges and falling edges of a clock, and the controller sequentially controls each of the buffers to transmit stored components to corresponding partition in a burst mode synchronized with the rising edges and falling edges of the clock.

5. The FCS control system of claim 4, wherein the controller synchronizes transmission of a plurality of components of one of the color channels to the memory at one of the rising edges of the clock, and synchronizes transmission of another plurality of components of a same color channel to the memory at one of the falling edge of the clock.

6. The FCS control system of claim 1, wherein the memory is divided such that components of a same color channel can be accessed continuously.

7. The FCS control system of claim 1, wherein the memory is divided such that components of a same color channel are grouped to be stored in adjacent addresses.

8. The FCS control system of claim 1 further comprising:
a light control module turning on and off a plurality of light sources independently, each light source corresponding to one of the color channels; and
a panel control module controlling a panel for displaying images;
wherein the output system, according to a color channel requirement, buffers the partition corresponding to a same color channel, and wherein when the light control module turns on one of the light sources corresponding to one of the color channels, the output system synchronously writes the partition corresponding to a same color channel to the panel control module.

9. The FCS control system of claim 8, wherein the output system further controls the panel control module for uniformly set the panel to display an image of a uniform color.

10. The FCS control system of claim 8, wherein the output system repeats to write one of the partitions to the panel control module.

11. The FCS control system of claim 1, wherein the output system repeats to output one of the partitions.

12. The FCS control system of claim 1, wherein each partition stores components, of a frame, corresponding to one of the color channels.
